(19) United States
(12) Patent Application Publication
(10) Pub. No.: US 2008/0192924 A1
(43) Pub. Date: Aug. 14, 2008

(54) Data encryption without padding

(75) Inventor: Heping Shang, Walnut Creek, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Sybase, Inc., Dublin, CA (US)

(21) Appl. No.: 11/705,033

(22) Filed: Feb. 12, 2007

(51) Int. Cl. H04L 9/28

(52) U.S. Cl. 380/28

(57) ABSTRACT

The present invention relates generally to data encryption. In particular, the present invention relates to methods of block cipher encryption and decryption. Embodiments of the present invention avoid padding in encrypting plain text messages having lengths that are non-integral multiples of a pre-determined block size. As such, encryption overhead savings can be achieved. Further, security from side-channel attacks can be increased.

### FIELD OF THE INVENTION

The present invention relates generally to data encryption. In particular, the present invention relates to methods of block cipher encryption and decryption.

### BACKGROUND OF THE INVENTION

Data encryption is employed in a variety of applications.

Block cipher encryption is a type of data encryption that operates on fixed-length groups of bits, typically called blocks, with an unvarying transformation. The transformation is typically controlled by a secret key to transform a plain text message into a cipher text message. Conversely, block cipher decryption employs the same key to retrieve the plain text message from the cipher text message.

Because block cipher encryption works on fixed-size blocks but plain text messages come in a variety of lengths, conventional block cipher encryption methods require that the final block in a plain text message be padded before encryption, unless the length of the plain text message is an integral multiple of the block size. For decryption, this requires that the plain text message length be either embedded in the plain text message or derivable from the padding message, which adds further complexity to these methods.

Several padding schemes exist. A commonly used scheme adds null bytes to the plain text message to bring its length to a multiple of the block size. This scheme however is especially vulnerable to side-channel attacks, which allow attackers to modify the underlying plain text by modifying an intercepted cipher text. Other schemes use more complex padding methods to prevent the risk of side-channel attacks.

As such, padding increases the complexity of block encryption. In addition, padding results in added overhead, which becomes a problem particularly in applications with limited space or capacity resources such as communications applications, for example.

What is needed therefore are methods of block cipher encryption and decryption without padding.

### BRIEF SUMMARY OF THE INVENTION

The present invention relates generally to data encryption. In particular, the present invention relates to methods of block cipher encryption and decryption. Embodiments of the present invention avoid padding in encrypting plain text messages having lengths that are non-integral multiples of a pre-determined block size. As such, encryption overhead savings can be achieved. Additionally, there is no need to embed the plain text message length for decryption purposes. Further, security from side-channel attacks can be increased.

Further features and advantages of the present invention, as well as the structure and operation of various embodiments thereof, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a block diagram that illustrates block cipher encryption.

FIG. 2 is an example block diagram that illustrates a conventional method of block cipher encryption.

FIG. 3 is an example block diagram that illustrates a method of block cipher encryption according to an embodiment of the present invention.

FIG. 4 is an example block diagram that illustrates a method of block cipher decryption according to an embodiment of the present invention.

FIG. 5 is a process flowchart of a method of block cipher encryption according to an embodiment of the present invention.

FIG. 6 illustrates an example computer useful for implementing components of the invention.

FIG. 7 is a process flowchart of a method of block cipher decryption according to an embodiment of the present invention.

The features and advantages of the present invention will become more apparent from the detailed description set forth below when taken in conjunction with the drawings. In the drawings, like reference numbers generally indicate identical, functionally similar, and/or structurally similar elements. Generally, the drawing in which an element first appears is indicated by the leftmost digit(s) in the corresponding reference number.

### DETAILED DESCRIPTION OF THE INVENTION

1 Block Cipher Encryption

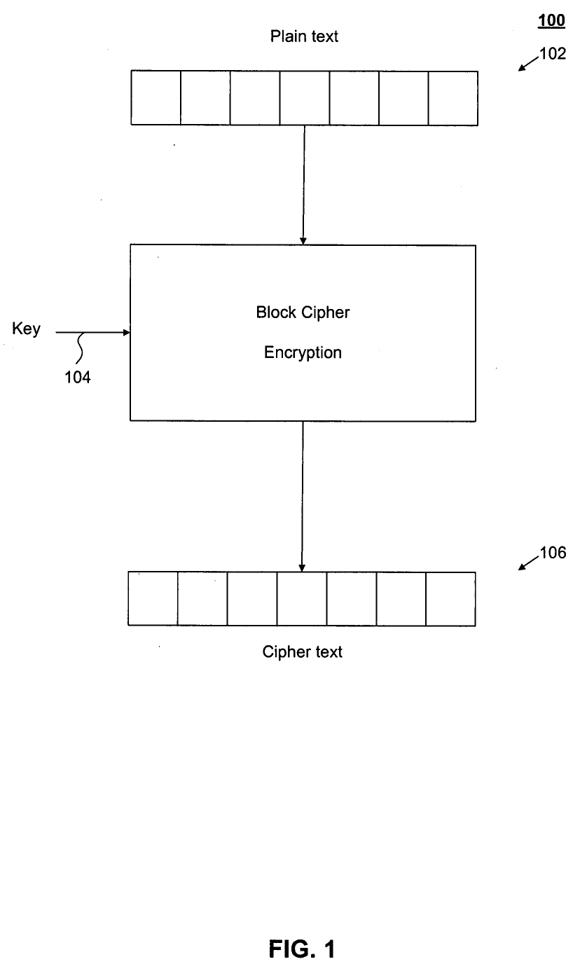

FIG. 1 is a block diagram 100 that illustrates block cipher encryption. Block cipher encryption works by applying a key cipher on fixed-length groups of bits, called blocks, to generate corresponding cipher text blocks. In FIG. 1, a plain text message 102 is block encrypted using a secret key 104 to generate a cipher text message 106. Plain text message 102 may include one or more full blocks and/or partial blocks. Similarly, cipher text message 106 may include one or more full blocks and/or partial blocks and may be of equal or different size as plain text message 102.

2 Block Cipher Encryption With Padding

Because block cipher encryption works on fixed-size blocks but plain text messages come in a variety of lengths, conventional block cipher encryption methods require that the final block in a plain text message be padded before encryption, unless the length of the plain text message is an integral multiple of the block size.

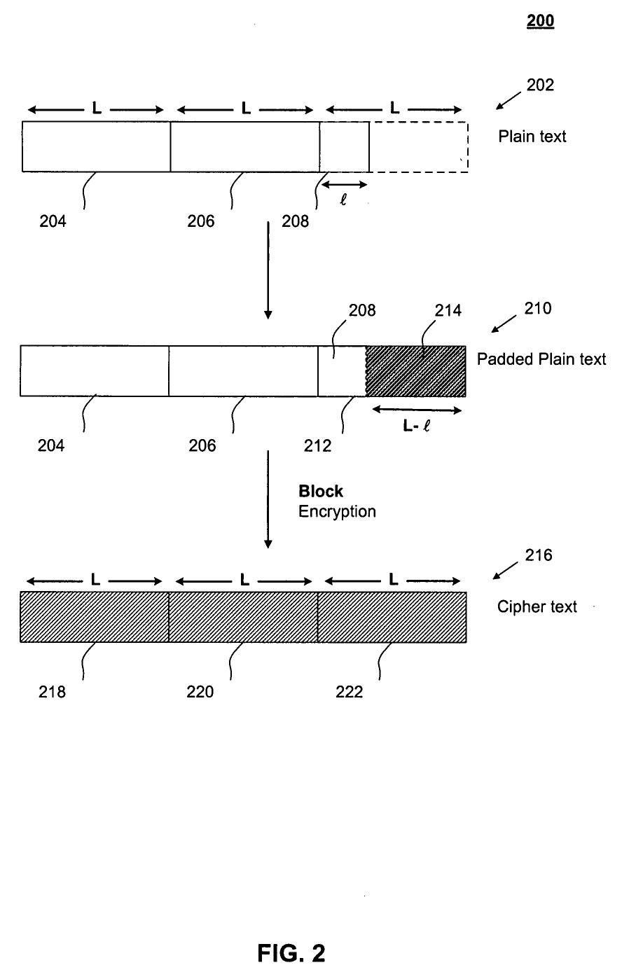

FIG. 2 is an example block diagram 200 that illustrates a conventional method of block cipher encryption. For ease of illustration, it is assumed that block cipher encryption in FIG. 2 operates on fixed-size blocks of size L bits. Plain text message 202 includes two integral blocks 204 and 206 of size L each and a partial block 208 of size 1 bits, where 1<L. As such, the size of plain text message 202 is a non-integral multiple of block size L.

For that reason, conventional block cipher encryption requires that plain text message 202 is padded to bring its length to an integral multiple of block size. As shown in FIG. 2, padding bits 214 of size L-1 are appended at the end of partial block 208 to form a padded plain text message 210. Padded plain text message 210 includes three integral blocks 204, 206, and 212 of size L each.

Encryption of padded plain text message 210 is then performed on a block-by-block basis to generate cipher text message 216. Cipher text message 216 includes three cipher text blocks 218, 220, and 222, which respectively correspond to blocks 204, 206, and 212 of padded plain text message 210. In the example of FIG. 2, cipher text blocks 218, 220, and 222 are illustrated to have a size of L bits each. This however may vary according to the used block encryption algorithm.

As described above, conventional block cipher encryption methods suffer from various problems including vulnerability to side-channel attacks and increased overhead. In the illustration of FIG. 2, for example, the overhead incurred due to encryption is equal to

$$\frac{L - l}{2 L - l} .$$

Note that when 1 tends to zero, the overhead incurred in this example approaches 50%. Further, conventional block cipher encryption methods require that the plain text message length be embedded in the cipher text message for decryption purposes. In one approach, the plain text message length is embedded in the plain text message. This, however, increases the overhead in the plain text message. Alternatively, the plain text message length is made derivable from the padding.

In the next section, methods of block encryption/decryption that avoid these inefficiencies of conventional block encryption are provided.

3 Block Cipher Encryption Without Padding

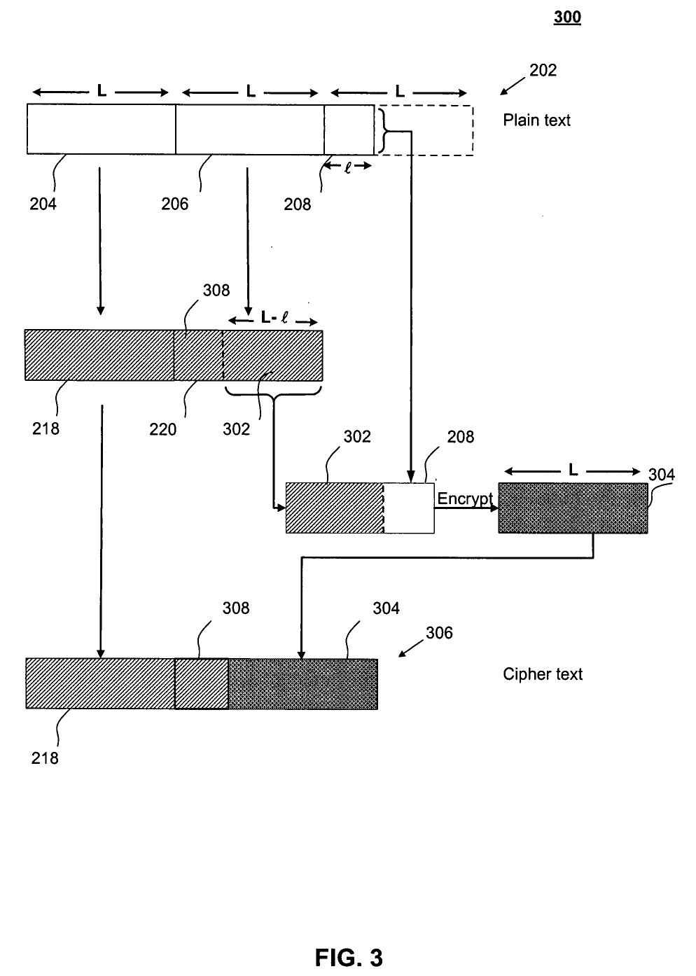

FIG. 3 is a block diagram 300 that illustrates a method of block cipher encryption according to an embodiment of the present invention. Similar to the example of FIG. 2, plain text message 202 includes two integral blocks 204 and 206 of size L each and a partial block 208 of size 1 bits, where 1<L. Integral blocks 204 and 206 of plain text message 202 are encrypted block-by-block to generate cipher text blocks 218 and 220, respectively.

Subsequently, a composite block is formed using a portion 302 of size L-1 of cipher text block 220 and partial block 208 of plain text message 202. The formed composite block is of size L bits and as such can be block encrypted. In the example of FIG. 3, the composite block is formed by appending partial block 208 at the end of portion 302. In another embodiment, portion 302 is appended at the end of partial block 208. Alternatively, other schemes for forming composite block 302 may be used. It is also noted that composite block 302 may be formed by combining a portion of cipher text block 218 and partial block 208 or by using portions of one or more of cipher text blocks 218 and 220.

Note that in implementation the composite block may or may not be physically formed. In other words, portion 302 and partial block 208 may be physically combined to generate an actual block of bits that is maintained in memory or may simply be logically linked together to define an imaginary or quasi-block.

Referring back to FIG. 3, since the formed quasi block is of block size L, it can be block encrypted to generate a cipher composite block 304. Cipher composite block 304 has size L.

Cipher text message 306 is then formed by combining cipher text block 218, a portion 308 of cipher text block 220, and cipher composite block 304. Portion 308 of cipher text block 220 is the complement of portion 302 of cipher text block 220. As such, portion 308 is of size 1. Cipher text block 306 therefore has a total size of 2L+1 and no encryption overhead.

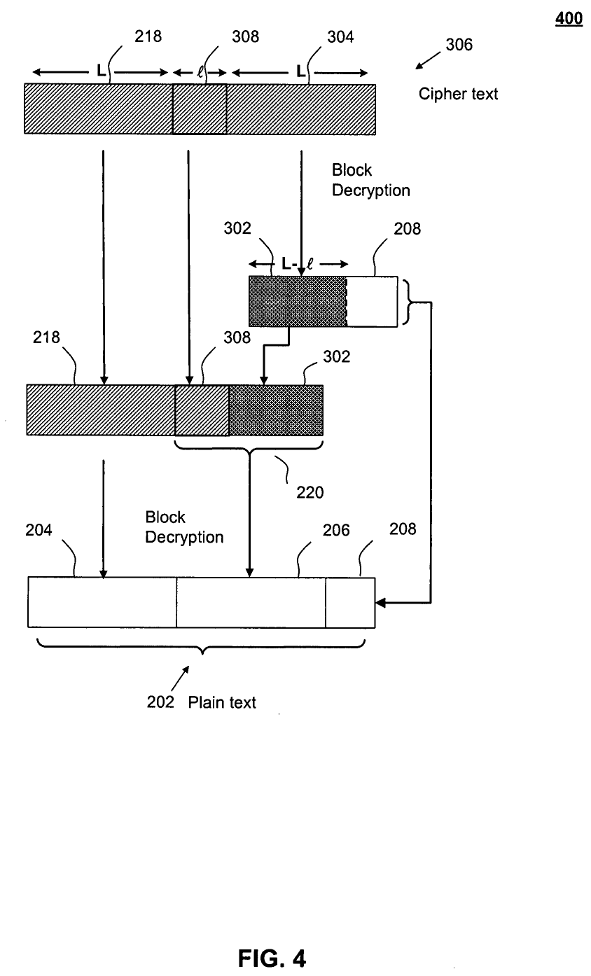

FIG. 4 is an example block diagram 400 that illustrates a method of block cipher decryption according to an embodiment of the present invention. Diagram 400 illustrates the decryption of cipher text message 306 of FIG. 3, which begins by decrypting cipher composite block 304 to retrieve portion 302 of cipher text block 202 and partial block 208 of plain text message 202. Subsequently, portion 302 is combined with portion 308 to re-generate cipher text block 220.

Cipher text blocks 218 and 220 are then decrypted in any order to retrieve plain text blocks 204 and 206, respectively. By appending partial block 208 to blocks 204 and 206, plain text message 202, which is the block cipher decryption of cipher text message 306, is retrieved.

As may appreciated by a person skilled in the art, variations on the embodiments illustrated in FIG. 3 and FIG. 4 exist. In one variation, encryption is performed by first encrypting the last (1+(L−1)) bits of the plain text message and then encrypting all the integral blocks in the plain text message. Decryption is then performed by decrypting all the integral blocks before decrypting the last (1+(L−1)) bits. In another variation, encryption is performed by first encrypting the last L bits of the plain text. As a result, a portion of the last integral block of the plain text is encrypted while a remaining portion is still in plain text. This forms a composite block, which can be encrypted as described above in FIG. 3.

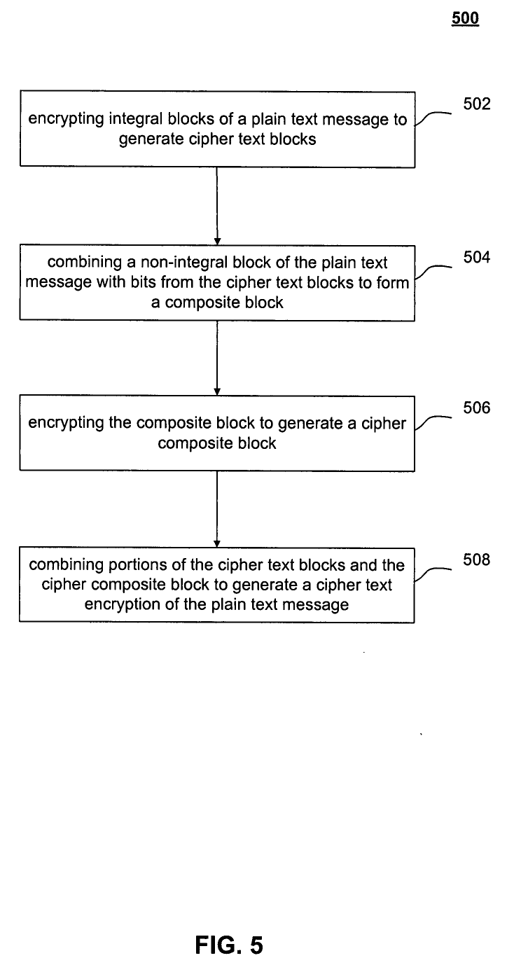

FIG. 5 is a process flowchart 500 of a method of block cipher encryption according to an embodiment of the present invention. Process 500 begins in step 502, which includes encrypting integral blocks of a plain text message to generate cipher text blocks. In an embodiment, the integral blocks are each of a pre-determined block size.

Step 504 includes combining a non-integral block of the plain text message with bits from the generated cipher text blocks, to generate composite block. The bits can be obtained from one or more of the cipher text blocks. In an embodiment, the combining is performed by appending the bits from the cipher text blocks at the end of the non-integral block of the plain text message. Alternatively, the bits are appended at the beginning of the non-integral block.

Step 506 includes encrypting the composite block to generate a cipher composite block. The composite block is encrypted in the same manner as the integral blocks.

Step 508 includes combining portions of the cipher text blocks and the cipher composite block to generate a cipher text encryption of the plain text message. In an embodiment, the combining is performed by combining the entirety of the cipher text blocks and the cipher composite block.

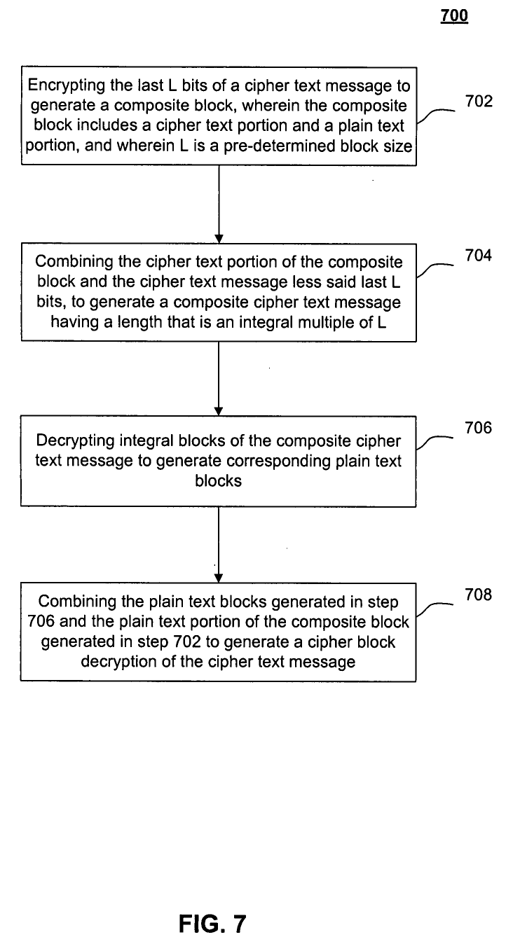

FIG. 7 is a process flowchart 700 of a method of block cipher decryption according to an embodiment of the present invention. Process 700 corresponds to encryption process 500. Process 700 begins in step 702, which includes decrypting the last L bits of a cipher text message to generate a composite block, wherein the composite block includes a cipher text portion and a plain text portion, and wherein L is a pre-determined block size. In FIG. 4, for example, this is illustrated by the decryption of block 304.

Step 704 includes combining the cipher text portion of the composite block and the cipher text message less the last L bits of the cipher text message, to generate a composite cipher text message having a length that is an integral multiple of L. In FIG. 4, for example, this is achieved by combining cipher text portion 302 and blocks 218 and 308 of cipher text message 306.

Step 706 includes decrypting integral blocks of the composite cipher text message to generate corresponding plain text blocks. Typically, decryption is performed beginning with the first integral block. In FIG. 4, for example, this is achieved by decrypting blocks 218 and 220.

Step 708 includes combining the plain text blocks generated in step 706 and the plain text portion of the composite block generated in step 702 to generate a cipher block decryption of the cipher text message.

4 Example Computer Implementation

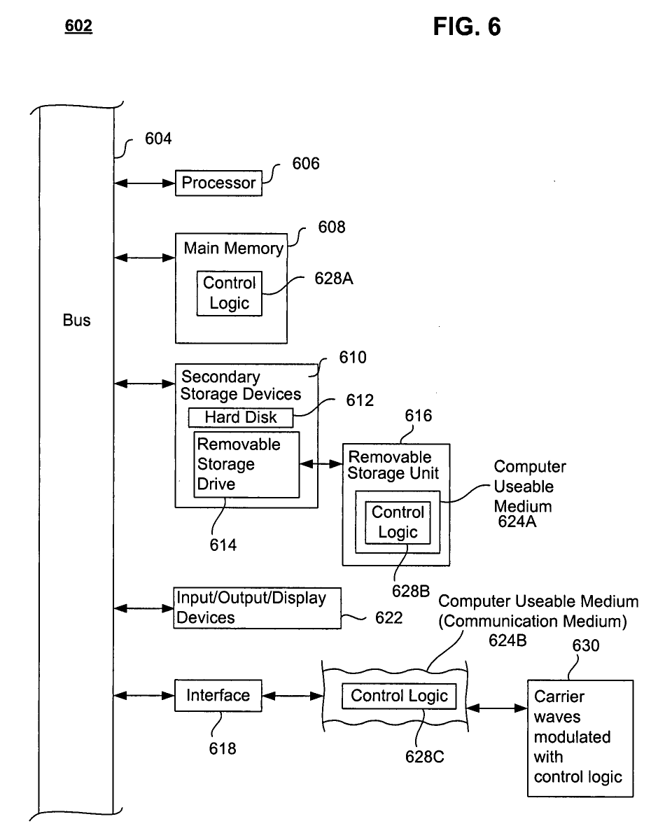

In an embodiment of the present invention, the system and components of the present invention described herein are implemented using well known computers, such as computer 602 shown in FIG. 6.

The computer 602 can be any commercially available and well known computer capable of performing the functions described herein, such as computers available from International Business Machines, Apple, Sun, HP, Dell, Compaq, Digital, Cray, etc.

The computer 602 includes one or more processors (also called central processing units, or CPUs), such as a processor 606. The processor 606 is connected to a communication bus 604.

The computer 602 also includes a main or primary memory 608, such as random access memory (RAM). The primary memory 608 has stored therein control logic 628A (computer software), and data.

The computer 602 also includes one or more secondary storage devices 610. The secondary storage devices 610 include, for example, a hard disk drive 612 and/or a removable storage device or drive 614, as well as other types of storage devices, such as memory cards and memory sticks. The removable storage drive 614 represents a floppy disk drive, a magnetic tape drive, a compact disk drive, an optical storage device, tape backup, etc.

The removable storage drive 614 interacts with a removable storage unit 616. The removable storage unit 616 includes a computer useable or readable storage medium 624 having stored therein computer software 628B (control logic) and/or data. Removable storage unit 616 represents a floppy disk, magnetic tape, compact disk, DVD, optical storage disk, or any other computer data storage device. The removable storage drive 614 reads from and/or writes to the removable storage unit 616 in a well known manner.

The computer 602 also includes input/output/display devices 622, such as monitors, keyboards, pointing devices, etc.

The computer 602 further includes a communication or network interface 618. The network interface 618 enables the computer 602 to communicate with remote devices. For example, the network interface 618 allows the computer 602 to communicate over communication networks or mediums 624B (representing a form of a computer useable or readable medium), such as LANs, WANs, the Internet, etc. The network interface 618 may interface with remote sites or networks via wired or wireless connections.

Control logic 628C may be transmitted to and from the computer 602 via the communication medium 624B. More particularly, the computer 602 may receive and transmit carrier waves (electromagnetic signals) modulated with control logic 630 via the communication medium 624B.

Any apparatus or manufacture comprising a computer useable or readable medium having control logic (software) stored therein is referred to herein as a computer program product or program storage device. This includes, but is not limited to, the computer 602, the main memory 608, the secondary storage devices 610, the removable storage unit 616 and the carrier waves modulated with control logic 630. Such computer program products, having control logic stored therein that, when executed by one or more data processing devices, cause such data processing devices to operate as described herein, represent embodiments of the invention.

The invention can work with software, hardware, and/or operating system implementations other than those described herein. Any software, hardware, and operating system implementations suitable for performing the functions described herein can be used.

5 Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method of block cipher encryption, comprising:
receiving a plain text message having a size that is a non-integral multiple of a pre-determined block size;
block encrypting an integral number of blocks in said plain text message to generate a corresponding number of cipher text blocks;
forming a quasi-block having the pre-determined block size from a remaining unencrypted portion of said plain text message having a size less than the predetermined block size and a complementary portion from one or more of said cipher text blocks;
block encrypting said quasi-block; and
combining said encrypted quasi-block and said cipher text blocks less said complementary portion to generate a cipher text encryption of said plain text message.

2. The method of claim 1, wherein said blocks in said plain text message are of fixed size.

3. The method of claim 1, wherein said cipher text blocks are of equal size as said blocks in said plain text message.

4. The method of claim 1, wherein the cipher text encryption of said plain text message is smaller in size than said plain text message.

5. A method of block cipher encryption, comprising:
(a) encrypting integral blocks of a plain text message to generate cipher text blocks;
(b) combining a non-integral block of said plain text message with bits from said cipher text blocks to form a composite block;
(c) encrypting said composite block to generate a cipher composite block; and
(d) combining portions of said cipher text blocks and said cipher composite block to generate a cipher text encryption of said plain text message.

6. The method of claim 5, wherein each of said integral blocks is of a pre-determined block size.

7. The method of claim 5, wherein said non-integral block is of a smaller size than said integral blocks.

8. The method of claim 5, wherein step (d) comprises combining the entirety of said cipher text blocks and said cipher composite block.

9. The method of claim 5, wherein step (d) comprises combining said cipher text blocks less said bits and said cipher composite block.

10. The method of claim 5, wherein step (b) comprises appending said bits from said cipher text blocks at the end of said non-integral block of said plain text message.

11. The method of claim 5, wherein step (b) comprises appending said bits from said cipher text blocks at the beginning of said non-integral block of said plain text message.

12. The method of claim 9, wherein said bits are obtained from one or more of said cipher text blocks.

13. A method of block cipher decryption, comprising:
(a) decrypting the last L bits of a cipher text message to generate a composite block, wherein said composite block includes a cipher text portion and a plain text portion, and wherein L is a pre-determined block size;
(b) combining the cipher text portion of the composite block and the cipher text message less said last L bits to generate a composite cipher text message;
(c) decrypting integral blocks of the composite cipher text message to generate corresponding plain text blocks; and
(d) combining the plain text blocks generated in step (c) and the plain text portion of the composite block generated in step (a) to generate a cipher block decryption of the cipher text message.

14. The method of claim 13, wherein said composite cipher text message has a length that is an integral multiple of L.

15. The method of claim 13, wherein said integral blocks have the pre-determined block size.

16. A computer program product comprising a computer useable medium having computer program logic recorded thereon for enabling a processor to perform block cipher encryption, the computer program logic comprising:
first encrypting means for enabling a processor to encrypt integral blocks of a plain text message to generate cipher text blocks;
first combining means for enabling a processor to combine a non-integral block of said plain text message with bits from said cipher text blocks to form a composite block;
second encrypting means for enabling a processor to encrypt said composite block to generate a cipher composite block; and
second combining means for enabling a processor to combine portions of said cipher text blocks and said cipher composite block to generate a cipher text encryption of said plain text message.
